(19) United States
(12) Patent Application Publication
(10) Pub. No.: US 2025/0010224 A1
(43) Pub. Date: Jan. 9, 2025

(54) METHOD FOR OPERATING A FILTER DEVICE AND FILTER DEVICE

(71) Applicant: MAAG GERMANY GmbH, Grossostheim (DE)

(72) Inventor: Harald POHL, Hopsten (DE)

(21) Appl. No.: 18/705,241

(22) PCT Filed: Oct. 20, 2022
(86) PCT No.: PCT/EP2022/079202

§ 371 Date: Apr. 26, 2024

(30) Foreign Application Priority Data
Oct. 28, 2021 (DE) 10 2021 128 195.4

(51) Int. Cl. B01D 29/66; B01D 29/11; B01D 29/52; B01D 29/60; B01D 29/90; B01D 29/92

(52) U.S. Cl. CPC B01D 29/668; B01D 29/114; B01D 29/52; B01D 29/606; B01D 29/902; B01D 29/925

(57) ABSTRACT

A method operates a filter device for polymer melt to be filtered. The filter device incorporates at least one first large-area filter in a first filter chamber and a second large-area filter in a second filter chamber; a first valve in a first inlet to the first filter chamber and a second valve in a second inlet to the second filter chamber to control the polymer melt to be filtered; a first drain valve in a first drain for the filtered polymer melt from the first filter chamber and a second drain valve in a second drain for the filtered polymer melt from the second filter chamber. The polymer melt to be filtered is conveyed under pressure through the filter device. The first inlet and the second inlet are connected to a common inlet and the first drain and the second drain are connected to a common drain. Polymer melt to be filtered is simultaneously fed to the first and second large-area filters in the filter direction. Parallel filtering is continuously performed via the first and second large-area filters. A backflushing operation for filtering via only one large-area filter is started when the large-area filter reaches a predefined degree of contamination at which the first large-area filter is cleaned.

This application is a national stage application filed under 35 U.S.C 371 of PCT Application No. PCT/EP2022/079202 filed Oct. 20, 2022, which claims priority to German Patent Application No. 10 2021 128 195.4 filed Oct. 28, 2021. The disclosures of the above-referenced applications are incorporated herein by reference in their entireties.

The invention relates to a method for operating a filter device, and to a filter device for carrying out the method.

In particular in the production of thermoplastics, it is common practice to remove foreign matter from the polymer melt by filtering it. Large-area filters are generally used for this purpose, which comprise a filter chamber having plural filter candles arranged therein, usually between 37 and 169. The large number of filter candles ensures that a large filter surface is available. In this process, the material to be filtered flows through the filter candles from the outside to the inside. The polymer melt to be filtered is filtered via the side walls of the filter candles. The side walls usually have a filter rating of between 3 μm and 20 μm.

For this purpose, it is common practice to use so-called duplex filter units. These duplex filter units have two identical filter means. Each filter means has a cylindrical filter chamber in which a large-area filter each is installed. The filter chamber and the large-area filter installed in it are preferably aligned vertically, with the material to be filtered flowing through them from bottom to top. The large-area filter is a filter that comprises several filter candles arranged on a distributor. The filter candles and the distributor divide the filter chamber into an inlet zone and an outlet zone. Polymer melt is fed to the filter candles via an inlet to the filter chamber. The supply of the polymer melt is controlled via an inlet valve, which is arranged in the respective inlet to the filter chamber. The side walls of the filter candles constitute the filter. More specifically, the side walls can be corrugated, or shaped in any other way, in the circumferential direction so as to increase the filter surface. The filter surfaces used are between 45 m² and 255 m², for example, which is the total of the side wall surfaces of all the filter candles. The filtered polymer melt exits through the side walls downstream of the distributor into the drain zone of the filter chamber and then into a drain from the filter chamber. The polymer melt is fed to the filter device via a pump. Stacked disk filters can also be used instead of filter candles.

Both filter means of the duplex filter device are always operated alternately, so that in the event of contamination of the one filter chamber with the contaminated large-area filter, it is possible to switch to the other filter chamber having the other large-area filter which is clean. This ensures continuous operation at all times.

For changing over from the one filter means to the other filter means, the valves in the inlet and drain are switched accordingly. The valve in the inlet to the filter chamber containing the contaminated large-area filter is closed, as is the drain valve in the drain from the filter chamber containing the contaminated large-area filter. At the same time, the inlet valve to the other filter chamber containing the clean large-area filter is opened, as is the drain valve in the drain from the filter chamber containing the clean large-area filter. The polymer melt in the filter chamber containing the contaminated large-area filter is drained via a drain valve in the inlet. The entire filter chamber containing the contaminated large-area filter is then removed from the filter device, or the filter chamber is opened and the distributor with the filter candles is removed and taken away for cleaning. Depending on the polymer type, pyrolysis processes, chemical solutions, ultrasonic baths and high-pressure cleaners are used for cleaning, which remove the plastic and the filtered-out foreign matter from the side walls of the filter candles.

A drawback of the method for operating the prior art filter devices, however, is that, because of the unused parallel filter unit of the duplex filter device, the total filter surface is always twice as large as is used in a basic mode of operation of the duplex filter device. As a result, investment costs are very high and capital is tied up. Cleaning is also very labor-intensive and time-consuming, especially if the filter means has to be transported to a specialist company for cleaning. The cleaning processes required to date are also disadvantageous from an environmental point of view.

It is the object of the invention, therefore, to further develop a method for operating a filter device of the type specified in the preamble of claim 1 in such a way that the efficiency of the filter device is increased and continuous operation is nevertheless ensured, whilst avoiding the above mentioned drawbacks.

This object is accomplished for the method for operating a filter device by the characterizing features of claim 1 in conjunction with the features of its preamble.

The dependent claims relate to advantageous further embodiments of the invention.

The invention is based on the insight that parallel operation of both filter chambers reduces the total filter surface and thus the overall size of a duplex filter device to half the amount, yielding a considerable cost advantage, and, upon contamination of one large-area filter, filtering is continued using only one large-area filter, whilst the other one is being cleaned by backflushing it with the polymer melt already filtered in the other large-area filter. Continuous operation is also maintained during backflushing.

The invention therefore provides for polymer melt to be filtered to be fed simultaneously to both the first large-area filter and the second large-area filter in the filter direction. Parallel and simultaneous filtering via the first and second large-area filters takes place continuously in a basic mode of operation. Filtering the polymer melt to be filtered is performed in a backflushing mode of operation using only one large-area filter. The backflushing mode of operation is initiated when both large-area filters have reached a predefined degree of contamination meaning that it is necessary to clean the first large-area filter using a backflushing mode of operation.

After cleaning the first large-area filter, the second large-area filter can be cleaned by backflushing. Backflushing one large-area filter always requires backflushing of the other large-area filter.

Preferably, one large-area filter is cleaned of contaminants during the backflushing mode of operation by reversing the flow direction of the filtered polymer melt and passing it through this one large-area filter. This is a simple way of eliminating the need for complex multi-stage cleaning processes, thereby increasing the efficiency of the filter device.

In particular once predetermined parameters for one large-area filter are met, the backflushing operation will be initiated for this large-area filter. These predetermined parameters are related to the degree of contamination of this large-area filter.

After cleaning one large-area filter, preferably followed by cleaning the other large-area filter, the duplex filter device is back in its basic mode of operation with parallel filter operation of both large-area filters until the backflushing parameters are met again, triggering the next backflushing cycle. Alternating between the basic and backflushing modes of operation can take place several times, which multiplies the service life of the duplex filter device.

In a particular embodiment of the invention, during the backflushing mode of operation, the inflow to this one large-area filter is interrupted, at least part of the filtered polymer melt of the other large-area filter is fed via the drain of the one large-area filter against the filter direction, is made to pass through the one large-area filter for cleaning the one large-area filter by backflushing and is then discharged. The already filtered polymer melt is thus used for cleaning the contaminated large-area filter. The filtered polymer melt, which then absorbs the contaminants from the large-area filter, is discharged and disposed of.

For discharging the contaminated polymer melt from the one large-area filter, the valve arranged in the inlet area can be opened, and the polymer melt filtered by the other large-area filter and then backflushed through the one large-area filter can be discharged via the valve.

Preferably, in the backflushing mode of operation, at least 1 time, preferably 1.5 times, preferably 2 times the volume of the filter chamber of the one large surface filter is discharged via the valve in the inlet. A predetermined quantity of backflushed polymer melt is used to ensure sufficient cleaning of the large-area filter.

In order to ensure that the polymer melt is also conveyed continuously in the backflushing mode of operation, the drain of this one large-area filter is partially closed via the associated drain valve for backflushing, for example by ⅔, by ⅓ or by ½, so that only part of the filtered polymer melt from the other large-area filter is fed to the one large-area filter for cleaning.

The cleaning effect in the backflushing mode of operation can be improved by briefly opening and closing the inlet valve or the drain valve of the one large-area filter, thus causing filtered polymer melt to flow through the one large-area filter, preferably several times in intervals, in particular intermittently.

Preferably, the polymer melt to be filtered is a low-viscosity polymer melt of 100 mPas, for example, which in particular comprises plastic raw materials, preferably molten plastics from chemical recycling.

Large-area filters with a filter rating of up to 3 μm can be used. This filters out particularly small contaminants from the polymer melt.

A method according to the invention preferably uses large-area filters having a filter surface of between 45 m² and 255 m².

The method according to the invention in particular uses large-area filters for differential pressures of between 1 bar and 100 bar.

For determining the degree of contamination on the large-area filter, the predetermined parameters for a large-area filter for the backflushing mode of operation are constituted by the pressure in the polymer melt to be filtered upstream of the large-area filter. Alternatively or additionally, the predetermined parameters can also be constituted by the differential pressure prevailing in the polymer melt to be filtered upstream of the large-area filter and in the filtered polymer melt downstream of the large-area filter. Pressure measurement is a particularly suitable means of determining the degree of contamination of the large-area filter, as the large-area filters become increasingly clogged over time, which directly affects the pressure increase upstream of the large-area filter and the differential pressure. This makes it easy to determine the degree of contamination and initiate the backflushing mode of operation, if necessary.

It is also possible for the predetermined parameters to be constituted by the operating time of a large-area filter. The predetermined operating time reflects in particular the experience with polymer melts to be filtered, namely how long on average it takes for a large-area filter to become contaminated.

In the method according to the invention, there is a laminar flow in the filter direction through the large-area filter in the basic mode of operation, and a pulsed flow against the filter direction through the large-area filter in the backflushing mode of operation.

Preferably, the pressure in the polymer melt on the drain side of the filter chamber to be backflushed is generated in a backflushing mode of operation by a melt pump arranged downstream of the drain side of the filter chambers.

On the drain side of the filter chamber to be backflushed, there is a higher pressure in the polymer melt in the backflushing mode of operation compared to the differential pressure on the large-area filter shortly before the backflushing mode of operation is initiated.

The pressure in the polymer melt on the drain side of the filter chamber with the large-area filter to be backflushed can be created in the backflushing mode of operation by pipelines and/or system components arranged downstream thereof, such as a throttle or a melt pump. For example, it is then possible to completely close the throttle arranged downstream of the large-area filter in a backflushing mode of operation and use the entire filtered polymer melt from the first large-area filter for backflushing the second large-area filter.

In particular, the filter device for carrying out a method comprises: a first filter chamber in which a first large-area filter is located and a second filter chamber in which a second large-area filter is located; a first inlet including a first inlet valve to the first filter chamber; a second inlet including a second inlet valve to the second filter chamber; a first drain from the first filter chamber; a second drain from the second filter chamber; a first drain valve in the first drain and a second drain valve in the second drain. Preferably, the inlet and drain valves are designed to be hydraulically and/or electrically actuated, and a control device is provided which controls the inlet and drain valves for setting the basic mode of operation and for setting the backflushing mode of operation.

Pressure sensors can be provided upstream and downstream of the filter chambers for determining the pressure in the polymer melt, which may be necessary to determine the degree of contamination of a large-area filter in the respective filter chamber.

More specifically, pressure sensors for determining the pressure in the polymer melt can be provided upstream and downstream of the large-area filter in the melt lines, thus allowing detection of the differential pressure acting on the large-area filter.

In one embodiment of the invention, the filter surface of the large-area filter in the filter chamber comprises stacked disk filters or filter candles.

To simplify manufacture and maintenance, the respective filter chambers, large-area filters, inlet valves and/or drain valves are all identical in design.

For example, a melt pump can be arranged in a common drain line and/or in the left- and right-hand drain lines, which can be used to control both the basic and the backflushing modes of operation.

Additional advantages, features and possible applications of the present invention will be apparent from the description which follows, in which reference is made to the embodiments illustrated in the drawings.

Throughout the description, the claims and the drawings, those terms and associated reference signs are used as are stated in the list of reference signs below. In the drawings,

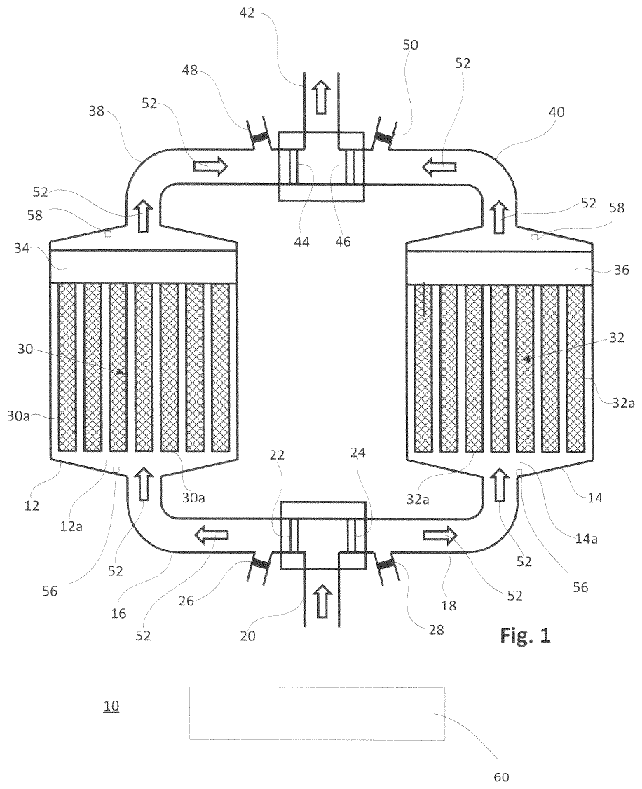

FIG. 1 is a schematic view of the filter device according to a first embodiment of the invention, in the basic mode of operation;

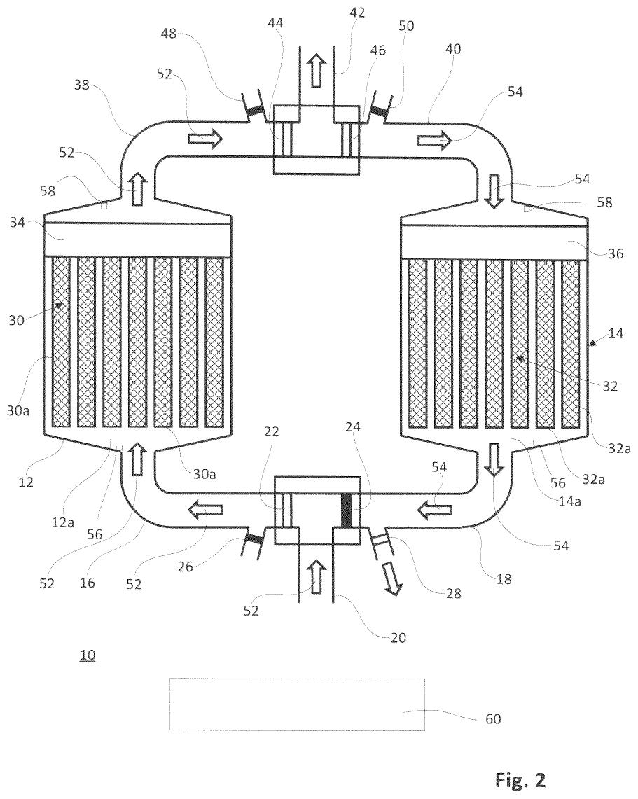

FIG. 2 is a schematic view of the filter device of FIG. 1, in the backflushing mode of operation;

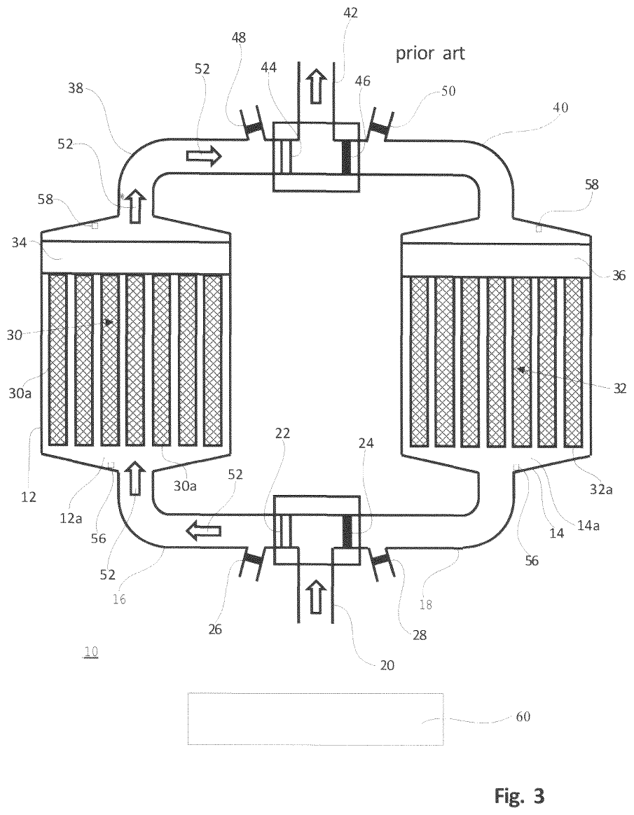

FIG. 3 is a schematic view of the filter device of FIG. 1, in a prior art mode of operation;

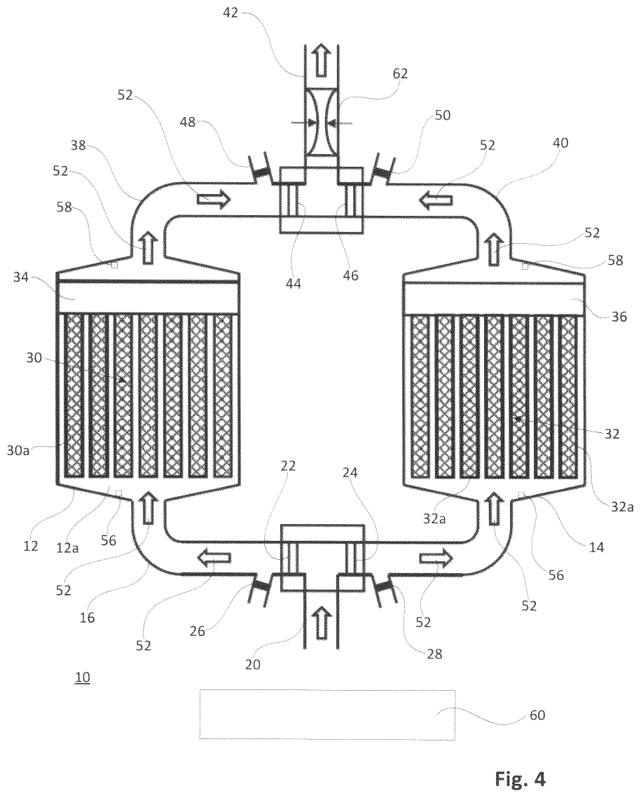

FIG. 4 is a schematic view of the filter device of a second embodiment of the invention, in the basic mode of operation;

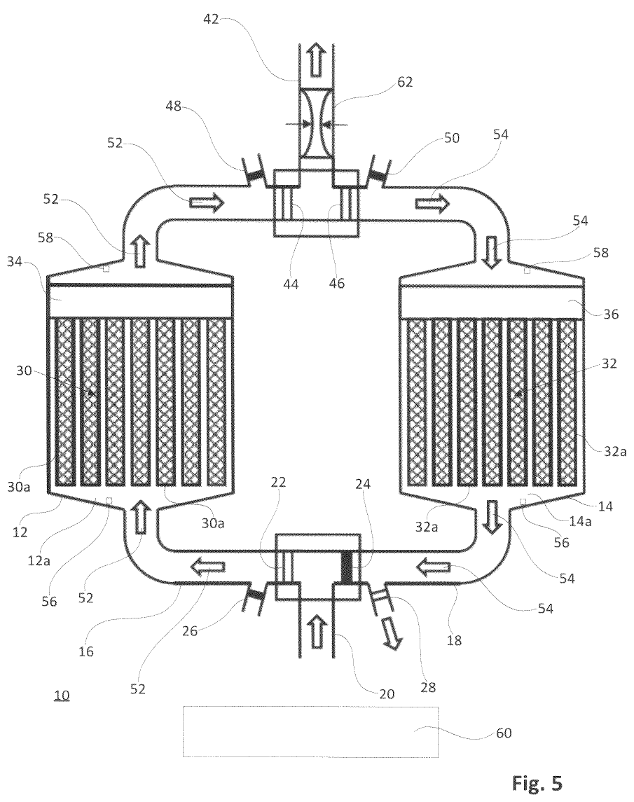

FIG. 5 is a schematic view of the filter device of FIG. 4, in the backflushing mode of operation;

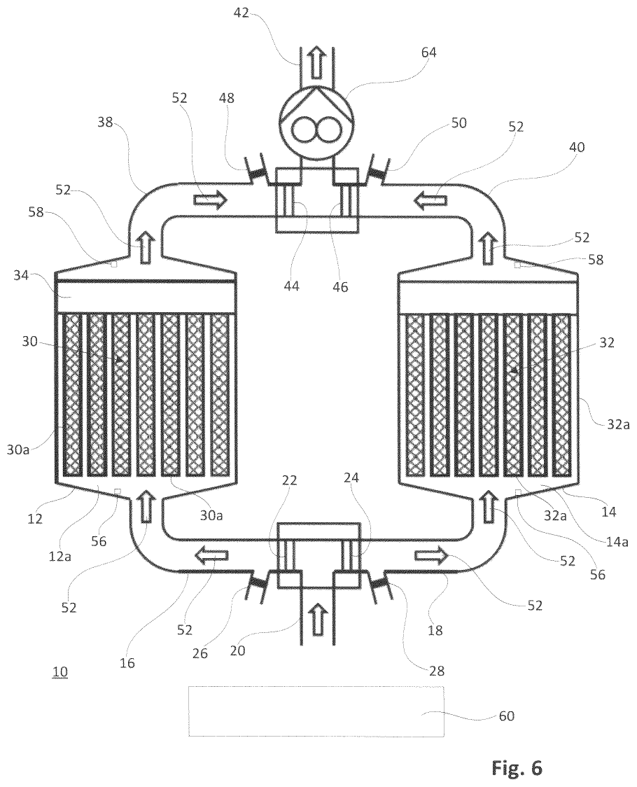

FIG. 6 is a schematic view of the filter device of a third embodiment of the invention, in the basic mode of operation;

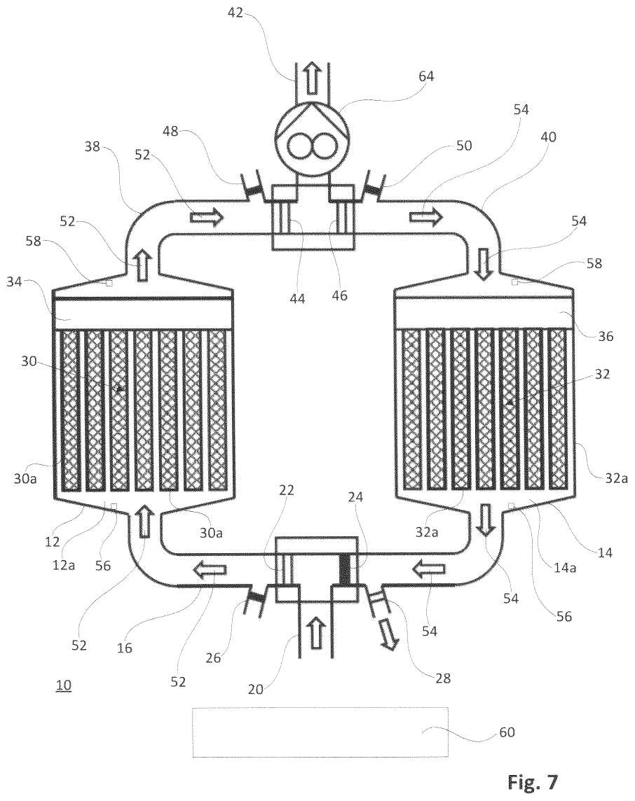

FIG. 7 is a schematic view of the filter device of FIG. 6, in the backflushing mode of operation;

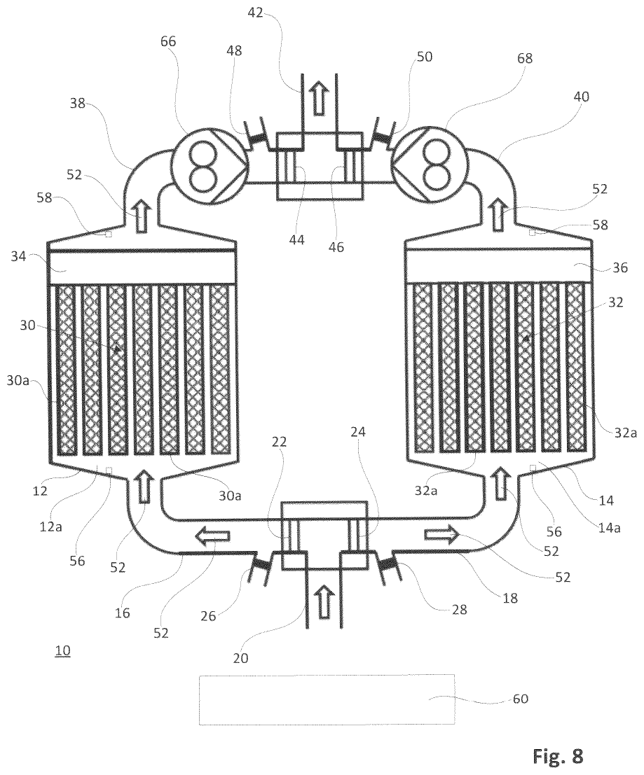

FIG. 8 is a schematic view of the filter device of a fourth embodiment of the invention, in the basic mode of operation;

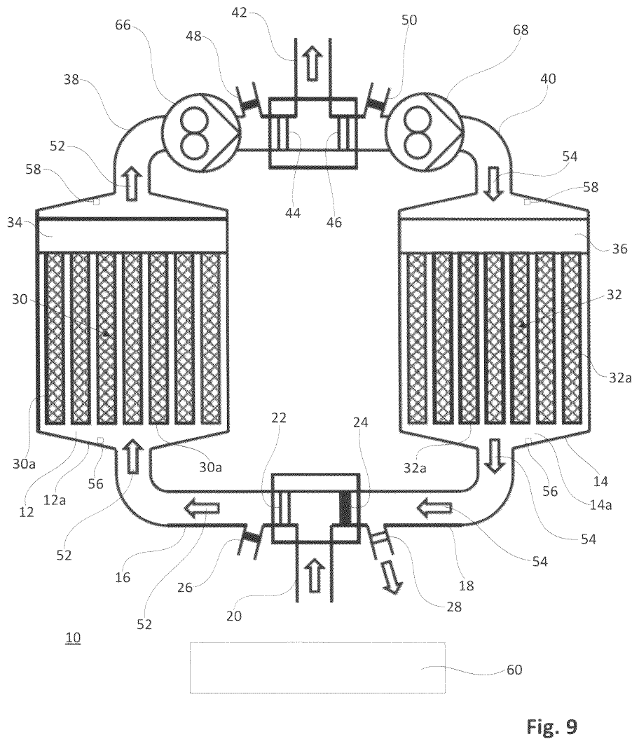

FIG. 9 is a schematic view of the filter device of FIG. 8, in the backflushing mode of operation; and

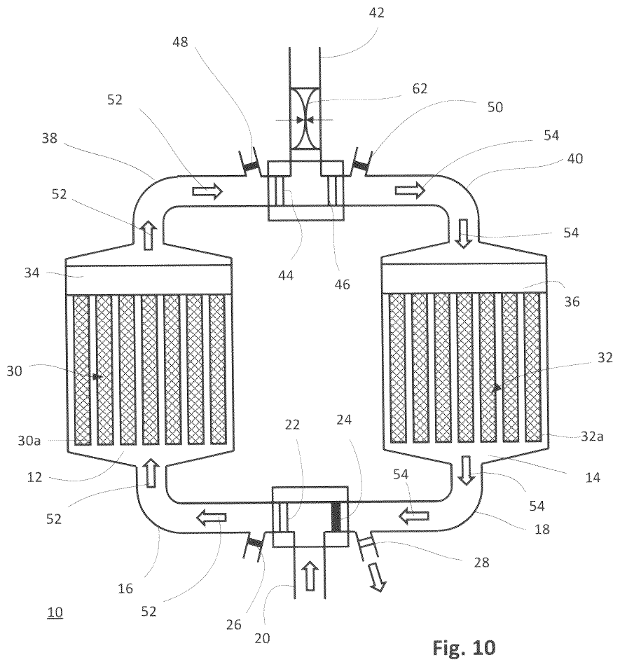

FIG. 10 is a schematic view of the filter device in a fifth embodiment of the invention in its basic operation mode.

Illustrated in FIGS. 1 to 2 is a filter device 10 for polymer melts to be filtered, according to a first embodiment of the invention. The filter device 10 comprises a left-hand filter chamber 12 and a right-hand filter chamber 14. The lower region 12a of filter chamber 12 and the lower region 14a of filter chamber 14 are each designed as a distributor. An inlet line 16, 18 is connected to the lower region 12a, 14a, with the left inlet line 16 ending in the lower region 12a of the left-hand filter chamber 12, and the right inlet line 18 ending in the lower region 14a of the right-hand filter chamber 14.

On the side of the inlet line 16, 18 remote from the filter chamber 12, 14, these lines are connected to a common inlet line 20. In the region of the common inlet line 20, the left inlet line 16 has a left-hand shut-off valve 22 and the right-hand inlet line 18 has a right-hand shut-off valve 24. The left-hand shut-off valve 22 can be used to control the flow of polymer melt to be filtered to the left-hand filter chamber 12, and the right-hand shut-off valve 24 can be used to control the flow of polymer melt to be filtered to the right-hand filter chamber 14.

A left-hand drain valve 26 is connected downstream of the left-hand shut-off valve 22 and a right-hand drain valve 28 is connected downstream of the right-hand shut-off valve 24 in the direction of flow of the polymer melt in a basic mode of operation. Polymer melt can be discharged from the respective inlet line 16, 18 as required via the left and right drain valves 26, 28.

In the left-hand filter chamber 12, a left-hand large-area filter 30 with a plurality of filter candles 30a is arranged. A right-hand large-area filter 32 with a plurality of filter candles 32a is arranged in the right-hand filter chamber 14. The filter candles 30a, 32a are aligned vertically parallel to one another and end in the upper region in a left distributor 34 or a right distributor 36, resp. Each large-area filter comprises, for example, 169 filter candles.

The filter candles 30a end in the left distributor 34, so that the polymer melt made to pass through the filter candles 30a from the outside to the inside is merged in the left-hand distributor 34 and discharged via a left-hand drain line 38 connected to the top of the filter chamber 12.

The filter candles 32a end in the right-hand distributor 36, so that the polymer melt made to pass through the filter candles 32a from the outside to the inside is merged in the right-hand distributor 36 and discharged via a right-hand drain line 40 connected to the top of the filter chamber 14.

The left-hand drain line 38 and the right-hand drain line 40 merge into a common drain line 42.

Upstream of the common drain line 42, the left-hand drain line 38 has a left-hand shut-off valve 44 installed therein, and the right-hand drain line 40 has a right-hand shut-off valve 46 installed therein. The left-hand shut-off valve 44 and the right-hand shut-off valve 46 can be used to shut off and open the left-hand drain line 38 and the right-hand drain line 40, respectively.

A left-hand vent valve 48 is connected upstream of the left-hand shut-off valve 44 in relation to the flow direction of the polymer melt in the basic mode of operation. In the same way, a right-hand vent valve 50 is connected upstream of the right-hand shut-off valve 46 in relation to the flow direction of the polymer melt in the basic mode of operation. These vent valves can be used to vent the respective side of the filter device 10.

The polymer melt to be filtered is forced through the large-area filters 30, 32 in the filter chambers 12, 14 to the common drain line 42 by a melt pump (not shown in detail in the figures) or by melt pressure caused by the process and acting on the common inlet line 20, and is thus conveyed through the filter device 10. There are different pressures prevailing in the polymer melt upstream and downstream of the large-area filter 30, 32. To detect this differential pressure, pressure sensors 56 are provided upstream of the respective large-area filter 39, 32, and pressure sensors 58 are provided downstream of the respective large-area filter 30, 32.

Both sides of the filter device 10 have the same components, i.e. filter chamber 12 corresponds to filter chamber 14, large-area filter 30 corresponds to large-area filter 32, etc.

Filter ratings of up to 3 μm are used for the large-area filter 30, 32. Preferably, the filter surface of one large-area filter 30, 32 is in a range of between 45 m² and 255 m². The differential pressures acting on the large-area filter 30, 32 are between 1 bar and 100 bar.

In a basic mode of operation, polymer melt to be filtered is fed simultaneously to both the left large-area filter 30 and the right large-area filter 32 in the filter direction, as indicated by the arrows 52 in FIG. 1. Parallel filtering is thus performed continuously by the left- and right-hand large-area filters 30, 32. The basic mode of operation is illustrated in FIG. 1.

In this case, the left-hand shut-off valve 22 in the left-hand inlet line 16 and the right-hand shut-off valve 24 in the right-hand inlet line 18 as well as the left-hand shut-off valve 44 in the left-hand drain line 38 and the right-hand shut-off valve 46 in the right-hand drain line 40 are all open. Via the common inlet line 20, the polymer melt to be filtered flows in equal proportions into the left-hand inlet line 16 and the right-hand inlet line 18.

From the left-hand inlet line 16, the polymer melt to be filtered contained in the distributor 12a spreads into the filter chamber 12 and penetrates the filter wall of the filter candles 30a. The now filtered polymer melt from the filter candles 30a is recombined via the distributor 34 and flows via the left-hand drain line 38 through the open left-hand shut-off valve 44 into the common drain line 42.

In the same way, the polymer melt to be filtered supplied through the right-hand inlet line 18 in the distributor 14a flows into the filter chamber 14 and penetrates the filter wall of the filter candles 32a. The now filtered polymer melt from the filter candles 32a is recombined via the distributor 36 and flows via the right-hand drain line 40 through the open right-hand shut-off valve 46 into the common drain line 42.

Illustrated in FIG. 2 is a backflushing mode of operation, namely the backflushing and thus cleaning of the right-hand large-area filter 32. By reversing the flow direction of the filtered polymer melt and passing the polymer melt through the right-hand large-area filter 32, the filter is cleaned of contaminants using filtered polymer melt. In the backflushing mode of operation, filtration continues using only the left-hand large-area filter 30. During backflushing and thus cleaning of the left-hand large-area filter 30, the polymer melt is filtered by means of the right-hand large-area filter 32 only.

The backflushing mode of operation is initiated as soon as the two large-area filters 30 and 32 have reached a predefined degree of contamination, i.e. it has become necessary to clean the large-area filters 30, 32 using a backflushing mode of operation.

In the example illustrated in FIG. 2, such a level of contamination has been reached and the backflushing mode of operation for the right-hand large-area filter 32 is initiated.

For initiating the backflushing mode of operation on the right-hand side, the right-hand shut-off valve 24 is first closed, thus blocking the right-hand inlet line 18. The right-hand shut-off valve 46 is closed next, blocking the right-hand drain line 40. Subsequently, the right-hand drain valve 28 is opened, allowing polymer melt to exit from the right-hand inlet line 18. The right-hand shut-off valve 46 is then opened again so as to cause backflushing through the right-hand large-area filter 32. The opening and closing of the right-hand shut-off valve 46 can take place at predetermined time intervals, resulting in a pulsating backflushing mode of operation. Alternatively, the shut-off valve 46 can also be open during the entire backflushing process, causing a laminar flow of the backflushed polymer melt through the right large-area filter 32.

Once backflushing has been completed, the right-hand drain valve 28 is closed and then the right-hand shut-off valve 24 is opened. The filter device 10 is now back in its basic mode of operation.

In the backflushing mode of operation of the right-hand large-area filter 32, the flow direction of the filtered polymer melt is reversed and the filtered polymer melt is passed through the right-hand large-area filter 32 and thus cleaned of contaminants. The polymer melt is filtered exclusively via the left large-area filter 30. The filtered polymer melt is made to flow against the filter direction as indicated by the arrow 54 for as long as required to fully clean the large-area filter 32 with its filter candles 32a. In doing so, 1 to 2 times the volume of the right-hand filter chamber 14 is discharged as a rule.

Once the backflushing mode of operation of the right-hand large-area filter 32 has been completed and the basic mode of operation has been restarted, the backflushing mode of operation is automatically initiated for the left-hand large-area filter 30.

To initiate the backflushing mode of operation on the left-hand side, the left-hand shut-off valve 22 is first closed, thus blocking the left-hand inlet line 16. The left-hand shut-off valve 44 is then closed, blocking the left-hand drain line 38. Subsequently, the left-hand drain valve 26 is opened, allowing polymer melt to exit from the left-hand inlet line 16. The left-hand shut-off valve 44 is then reopened, causing backflushing through the left-hand large-area filter 30. Opening and closing of the left-hand shut-off valve 44 can take place at predetermined time intervals, resulting in a pulsating backflushing mode through the left large-area filter 30. Alternatively, the shut-off valve 44 can also be open for the entire backflushing operation, causing the backflushed polymer melt to pass through the left-hand large-area filter 30 in a laminar flow.

During backflushing of the left large-area filter 30, the polymer melt is filtered exclusively via the right large-area filter 32. The filtered polymer melt is made to flow against the filter direction as indicated by the arrow 54 for as long as it takes to fully clean the large-area filter 30 with its filter candles 30a. In doing so, 1 or 2 times the volume of the left filter chamber 12 is discharged as a rule.

Once the left-hand large-area filter 30 has been cleaned, the backflushing mode of operation and thus a backflush cycle, in which both large-area filters 30 and 32 are cleaned the one after the other, is terminated and the basic mode of operation, as described above, starts again.

The backflushing cycle is initiated as soon as predetermined parameters for the backflushing mode of operation have been met. These parameters can be constituted by the pressure prevailing in the polymer melt to be filtered upstream of the large-area filter 30, 32, which is detected by the pressure sensor 56. In addition or alternatively, these parameters can be constituted by the differential pressure which prevails in the polymer melt to be filtered upstream of the large-area filter 30, 32 and in the filtered polymer melt downstream of the large-area filter, which pressure is measured in each case by the pressure sensors 56 and 58. In addition and alternatively, the parameters can also be constituted by the operating time since commissioning and/or the last backflushing for this large-area filter 30, 32.

The shut-off valves 22, 24 in the inlet lines 16, 18, the drain valves 26, 28 in the inlet lines 16, 18, the shut-off valves 44, 46 in the drain lines 38, 40 and the vent valves 48, 50 in the drain lines 38, 40 are hydraulically and/or electrically actuated and are controlled by a control device 60. For this purpose, the control unit 60 is connected to corresponding actuators. For reasons of clarity, the line connections and the valve actuators are not shown. In addition, the control device 60 is connected to the pressure sensors 56 and 58 to detect the respective pressures in the polymer melt.

As has already been explained, instead of a constant setting of the shut-off valve 44, 46 in the backflushing mode of operation in the drain line 38, 40, for example ⅓ closed, an intermittent flow of filtered polymer melt through this large-area filter 30, 32 can be caused by continuously opening and closing the shut-off valve 44, 46 in the drain line 38, 40 of the large-area filter 30, 32 to be backflushed for a short time. Both the basic and the backflushing modes of operation are controlled via the control unit.

Illustrated in FIGS. 4 and 5 is yet another embodiment of the invention. It essentially corresponds to the embodiment described with reference to FIGS. 1 and 2. Therefore, the same reference signs were used to designate the same parts. The only difference is that an adjustable throttle 62 is installed in the common drain line 42. FIG. 4 shows the basic mode of operation, and FIG. 5 shows of the backflushing mode of operation on the right-hand side. In the backflushing mode of operation on the right-hand side, the adjustable throttle 62 is used to ensure that the pressure upstream of the throttle 62 increases and the polymer melt is thus backflushed into the right-hand large-area filter 32.

Illustrated in FIGS. 6 and 7 is yet another embodiment of the invention. It essentially corresponds to the embodiment described with reference to FIGS. 1 and 2. Therefore, the same reference signs were used to designate the same parts. The only difference is that an adjustable throttle 64 is installed in the common drain line 42. FIG. 6 shows the basic mode of operation and FIG. 7 shows the backflushing mode of operation on the right-hand side. In the backflushing mode of operation on the right-hand side, the adjustable throttle 64 is used to ensure that the pressure upstream of the throttle 64 increases and the polymer melt is thus backflushed into the right-hand large-area filter 32.

Illustrated in FIGS. 8 and 9 is yet another embodiment of the invention. It essentially corresponds to the embodiment described with reference to FIGS. 1 and 2. Therefore, the same reference signs were used to designate the same parts. The only difference is that a controllable left-hand melt pump 66 is installed in the left-hand drain line 38, and a controllable right-hand melt pump 68 is installed in the right-hand drain line 40. FIG. 8 shows the basic mode of operation, and FIG. 9 shows the backflushing mode of operation on the right-hand side. In the backflushing mode of operation on the right-hand side, the controllable melt pumps 66 and 68 are used to ensure that the polymer melt is backflushed into the right-hand large-area filter 32.

FIG. 10 shows yet another embodiment of the invention. It essentially corresponds to the embodiment described with reference to FIGS. 1 and 2. Therefore, the same reference signs were used to designate the same parts. The view illustrates a backflushing mode of operation with the throttle 62 closed, whereby the entire cleaned polymer flow from the left large-area filter 30 flows into the right large-area filter 32 and flows backwards through it for cleaning.

The invention is characterized by providing a simple way of using already filtered polymer melt for cleaning large-area filters 30, 32. This cuts costs significantly, and the size of the filter device 10 can be reduced considerably by running both large-area filters 30, 32 simultaneously in a basic mode of operation.

### LIST OF REFERENCE SIGNS

10 filter device
12 left-hand filter chamber
12a lower region of left-hand filter chamber 12
14 right-hand filter chamber
14a lower region of right-hand filter chamber 14
16 left-hand inlet line
18 right-hand inlet line
20 common inlet line
22 left-hand shut-off valve
24 right-hand shut-off valve
26 left-hand drain valve
28 right-hand drain valve
30 left-hand large-area filter
30a filter candle of left-hand large area filter 30
32 right-hand large-area filter
32a filter candle of right-hand large-area filter 32
34 left-hand distributor
36 right-hand distributor
38 left-hand drain line
40 right-hand drain line
42 common drain line
44 left-hand shut-off valve
46 right-hand shut-off valve
48 left-hand vent valve
50 right-hand vent valve
52 arrows indicating the polymer melt flow direction in basic operation
54 arrows indicating the polymer melt flow direction in backflushing
operation
56 pressure sensors upstream of large-area filter 30, 32
58 pressure sensors downstream of large-area filter 30, 32
60 control device
62 adjustable throttle
64 controllable melt pump
66 controllable left-hand melt pump
68 controllable right-hand melt pump

1. A method for operating a filter device for a polymer melt to be filtered, said filter device comprising: at least one first large-area filter in a first filter chamber and a second large-area filter in a second filter chamber; a first valve in a first inlet to the first filter chamber and a second valve in a second inlet to the second filter chamber in order to control the polymer melt to be filtered; a first drain valve in a first drain for the filtered polymer melt from the first filter chamber and a second drain valve in a second drain for the filtered polymer melt from the second filter chamber; wherein
the polymer melt to be filtered is conveyed under pressure through the filter device, wherein the first inlet and the second inlet are connected to a common inlet and the first drain and the second drain are connected to a common drain, polymer melt to be filtered is simultaneously fed to both the first large-area filter and the second large-area filter in the filter direction, and parallel filtering is continuously performed via the first and second large-area filters in a basic mode of operation, and merely filtering in a backflushing mode of operation is performed via only one large-area filter, which backflushing mode of operation is started when the large-area filter has reached a predefined degree of contamination at which the first large-area filter is cleaned using a backflushing operation.

2. A method according to claim 1, wherein after cleaning by a backflushing mode of operation of the first large-area filter, the backflushing mode of operation of the second large-area filter is started.

3. A method according to claim 1, wherein during the backflushing mode of operation, one large-area filter is cleaned of contaminants by reversing the flow direction of the filtered polymer melt and passing it through this one large-area filter.

4. A method according to claim 1, wherein the backflushing mode of operation for one large-area filter is started when predetermined physical parameters are present in the polymer melt for the large-area filters.

5. A method according to claim 4, wherein, in the backflushing mode of operation, the inflow of polymer melt to this one large-area filter is interrupted, at least part of the filtered polymer melt of the other large-area filter is fed via the drain of the one large-area filter against the filter direction, is passed through the one large-area filter for cleaning the one large-area filter by backflushing, and is then discharged.

6. A method according to claim 5, wherein the valve arranged in the region of the inlet is opened for discharging the filtered polymer melt from one large-area filter, and the valve is used for discharging polymer melt filtered by the other large-area filter and subsequently backflushed through the one large-area filter.

7. A method according to claim 1, wherein, in the backflushing mode of operation, 1 to 2 times the volume of the filter chamber of the one large-area filter is discharged via the valve in the inlet.

8. A method according to claim 1, wherein, in the backflushing mode of operation, the drain of this one large-area filter is partially closed via the associated drain valve for backflushing, by ⅔, by ⅓ or by ½, so that only part of the filtered polymer melt from the other large-area filter is fed to the one large-area filter for cleaning.

9. A method according to claim 1, wherein, for the backflushing mode of operation, filtered polymer melt flows through the one large-area filter, preferably several times, at intervals, intermittently, by opening and closing the drain valve of the one large-area filter.

10. A method according to claim 1, wherein a low-viscosity polymer melt is used as the polymer melt to be filtered, which comprises molten plastics for chemical recycling.

11. A method according to claim 1, wherein the viscosity of the polymer melt to be filtered is in the range of between 70 mPas and 90 mPas, in particular 80 mPas.

12. A method according to claim 1, wherein a large-area filter with a filter rating of up to 3 μm is used.

13. A method according to claim 1, wherein a large-area filter with a filter surface of between 45 m² and 255 m² is used.

14. A method according to claim 1, characterized in that large-area filters are used for differential pressures of between 1 bar and 100 bar.

15. A method according to claim 2, wherein the predetermined parameters for a large-area filter for the backflushing mode of operation are constituted by the pressure acting on the large-area filter in the polymer melt to be filtered upstream of the large-area filter, are constituted by the differential pressure which results in the polymer melt to be filtered upstream of the large-area filter and in the filtered polymer melt downstream of the large-area filter, and/or is formed by the operating time of a large-area filter.

16. A method according to claim 1, wherein a laminar flow in the filter direction through the large-area filter in a basic mode of operation, and a pulsed flow against the filter direction through the large-area filter in the backflushing mode of operation.

17. A method according to claim 1, wherein the pressure in the polymer melt on the drain side of the filter chamber to be backflushed is generated during a backflushing mode of operation by a melt pump which is arranged downstream of the drain side of the filter chambers.

18. A method according to claim 1, wherein, on the drain side of the filter chamber to be backflushed, the pressure prevailing in the polymer melt in the backflushing mode of operation is higher compared to the differential pressure acting on the large-area filter shortly before the backflushing mode of operation is initiated.

19. A method according to claim 1, wherein, in the backflushing mode of operation, the pressure in the polymer melt on the drain side of the filter chamber with the large-area filter to be backflushed is generated by lines and/or system components, such as a throttle, arranged downstream thereof.

20. A method according to claim 19, wherein, in the throttle arranged downstream of the large-area filter is completed closed in a backflushing mode of operation, and the entire filtered polymer melt from the first large-area filter is used for backflushing the second large-area filter.

21. A filter device, comprising:
a first filter chamber in which a first large area filter is located, and a second filter chamber in which a second large area filter is located, a first inlet with a first inlet valve to the first filter chamber, a second inlet with a second inlet valve to the second filter chamber, a first drain from the first filter chamber, a second drain from the second filter chamber,
a first drain valve in the first drain, a second drain valve in the second drain, wherein the inlet valves and the drain valves are designed to be hydraulically and/or electrically actuated, that a control device is provided which controls the inlet valves and the drain valves for setting the basic and backflushing modes of operation, respectively, the filter device carrying out a method wherein a polymer melt to be filtered is conveyed under pressure through the filter device, wherein the first inlet and the second inlet are connected to a common inlet and the first drain and the second drain are connected to a common drain, polymer melt to be filtered is simultaneously fed to both the first large-area filter and the second large-area filter in the filter direction, and parallel filtering is continuously performed via the first and second large-area filters in a basic mode of operation, and merely filtering in a backflushing mode of operation is performed via only one large-area filter, which backflushing mode of operation is started when the large-area filter has reached a predefined degree of contamination the first large-area filter is cleaned using a backflushing operation.

22. A filter device according to claim 20, wherein pressure sensors for determining the pressure in the polymer melt are provided upstream and downstream of the filter chambers.

23. A filter device according to claim 20, wherein pressure sensors for determining the pressure in the polymer melt are provided in the filter chambers upstream of the large-area filter and downstream of the large-area filter.

24. A filter device according to claim 10, wherein the filter surface of the large-area filter in the filter chamber is formed by stacked disk filters or by filter candles.

25. A filter device according to claim 20, wherein all the filter chambers, all the large-area filters, all the inlet valves and/or all the drain valves are identical in design.

26. A filter device according to claim 19, wherein a melt pump is arranged in a common drain line or in the left and right drain lines.
